(19) United States
(12) Patent Application Publication
(10) Pub. No.: US 2017/0301349 A1
(43) Pub. Date: Oct. 19, 2017

(54) SPEECH RECOGNITION SYSTEM

(71) Applicant: MITSUBISHI ELECTRIC CORPORATION, Tokyo (JP)

(72) Inventors: Yuki SUMIYOSHI, Tokyo (JP); Takumi TAKEI, Tokyo (JP); Naoya BABA, Tokyo (JP)

(73) Assignee: MITSUBISHI ELECTRIC CORPORATION, Tokyo (JP)

(21) Appl. No.: 15/509,981

(22) PCT Filed: Dec. 26, 2014
(86) PCT No.: PCT/JP2014/084571

§ 371 Date: Mar. 9, 2017

(51) Int. Cl. G10L 15/22; G01C 21/36; G06F 3/0481; G06F 3/0482; G06F 3/16

(52) U.S. Cl. CPC G10L 15/22; G06F 3/0482; G06F 3/167; G01C 21/3608; G06F 3/04817; G10L 2015/223

(57) ABSTRACT

A speech recognition system includes a speech acquisition unit for acquiring speeches uttered by a user for a preset sound acquisition period, a speech recognition unit for recognizing the speeches acquired by the speech acquisition unit, a determination unit for determining whether the user performs a predetermined operation or action, and a display control unit for displaying, when the determination unit determines that the user performs the predetermined operation or action, a function execution button for causing a navigation system to execute a function corresponding to a result of the recognition by the speech recognition unit on a display unit.

### TECHNICAL FIELD

The present invention relates to speech recognition systems for recognizing speech utterances by users.

### BACKGROUND ART

In some of conventional speech recognition systems, a user has to think and prepare things he or she wishes the system to recognize. After that, the user may instruct the system to activate the speech recognition function by, for example, pressing a push-to-talk (PTT) button, and then utter a speech. According to such systems, a word appearing in a natural conversation between the users cannot be automatically recognized. Accordingly, in order for the system to recognize such word, the user has to press the PTT button or the like and pronounce the word again. Thus, there have been problems that operating the system is bothersome, and that the user may forget things he/she wishes the system to recognize.

In contrast to this, there is a speech recognition system for performing speech recognition continuously on speeches collected by a microphone. According to such speech recognition system, because a speech recognition start instruction needs not to be issued by the user, the above-described bother is resolved. However, since a function corresponding to a recognition result is automatically executed irrespective of an operation intention of the user, the user may be confused.

Here, in Patent Literature 1, there is described an operation control apparatus for continuously recognizing speeches, and generating and displaying a shortcut button for executing a function associated with a recognition result.

### CITATION LIST

### Patent Literatures

Patent Literature 1: JP 2008-14818 A

### SUMMARY OF INVENTION

### Technical Problem

According to the operation control apparatus of the above-described Patent Literature 1, a function associated with a recognition result is executed only after the user presses the shortcut button. This can prevent an unintentional operation from being automatically performed irrespective of the intention of the user. Nevertheless, in the case of Patent Literature 1, part of information displayed on a screen is hidden by the shortcut button, and screen update performed when the shortcut button is displayed generates a change in display content. This causes a problem that the operation may cause the user to feel uncomfortable or impair the concentration of the user when, for example, driving.

The present invention has been devised for solving the above-described problems, and the object of the present invention is to provide a speech recognition system that can continuously recognize speech, and present a function execution button for executing a function corresponding to a recognition result, at a timing required by the user.

### Solution To Problem

A speech recognition system according to the present invention including: a speech acquisition unit for acquiring speeches littered by a user for a preset sound acquisition period; a speech recognition unit for recognizing the speeches acquired; by the speech acquisition unit; a determination unit for determining whether the user performs a predetermined operation or action; and a display control unit fox displaying, when the determination unit determines that the user performs the predetermined operation or action, a function execution button for causing a device to be controlled to execute a function corresponding to a result of the recognition by the speech recognition unit on a display unit.

### ADVANTAGEOUS EFFECTS OF INVENTION

According to an aspect of the present invention, speech utterances of the user are imported over the preset sound acquisition period, and a function execution button corresponding to a speech utterance is displayed when a predetermined operation or action is performed by the user. This configuration can resolve the bother of pressing the PTT button and speaking again the word appeared in conversation. In addition, operations that are against the intention of the user are not performed. Furthermore, impairment in concentration that is caused by screen update performed when the function execution button is displayed can be suppressed. Additionally, a function execution button that foresees operation intention of the user is presented for the user. Thus, user-friendliness and usability can be enhanced.

### BRIEF DESCRIPTION OF DRAWINGS

FIG. 1 is a block diagram illustrating an example of a navigation system to which a speech recognition system according to a first embodiment of the present invention is applied.

FIG. 2 is a schematic configuration diagram illustrating a main hardware configuration of tile navigation system to which the speech recognition system according to the first embodiment is applied.

FIGS. 3A and 3B are an explanatory diagram, for illustrating an overview of an action of the speech recognition system according to the first embodiment.

FIG. 4 is a diagram illustrating examples of a recognition result character string included in a recognition result and a recognition result type.

FIG. 5 is a diagram illustrating examples of a relation between a recognition result type and a function to be allocated to a function execution button.

FIG. 6 is a flowchart illustrating a process of holding a recognition result about speech utterances by the user in the speech recognition system according to the first embodiment.

FIG. 7 is a flowchart illustrating a process for displaying a function execution button according to the speech recognition system of the first embodiment.

FIGS. 8A-8D are a diagram illustrating display examples of function execution buttons.

FIG. 9 is a diagram illustrating examples of recognition results stored by a recognition result storing unit.

FIGS. 10A and 10B are a diagram illustrating examples of a display mode of a function execution button.

FIG. 11 is a block diagram illustrating a modified example of the speech recognition system according to the first embodiment.

FIG. 12 is a diagram illustrating examples of a relation between a user operation and a recognition result type.

FIG. 13 is a flowchart illustrating a process for displaying a function execution button according to a speech recognition system of a second embodiment of the present invention.

FIGS. 14A and 14B are a diagram illustrating another display example of one or more function execution buttons.

FIG. 15A is a diagram illustrating examples of a relation between a user's speech utterance and a recognition result type, while FIG. 15B is a diagram illustrating examples of a relation between a user's gesture and a recognition result type.

FIG. 16 is a block diagram illustrating an example of a navigation system to which a speech recognition system according to a third embodiment of the present invention is applied.

FIG. 17 is a flowchart illustrating a process of importing and holding a user's speech in the speech recognition system according to the third embodiment.

FIG. 18 is a flowchart illustrating a process of displaying a function execution button in the speech recognition system according to the third embodiment.

### DESCRIPTION OF EMBODIMENTS

For describing the present invention in more detail, embodiments for carrying out the present invention will be described below in accordance with the attached drawings.

Note that although the following embodiments will be explained in accordance with an exemplary case in which a speech recognition system of the present invention is applied to a navigation system (device to be controlled) for a movable body such as a vehicle, the speech recognition system may be applied to any system with a sound operation function.

### Embodiment 1

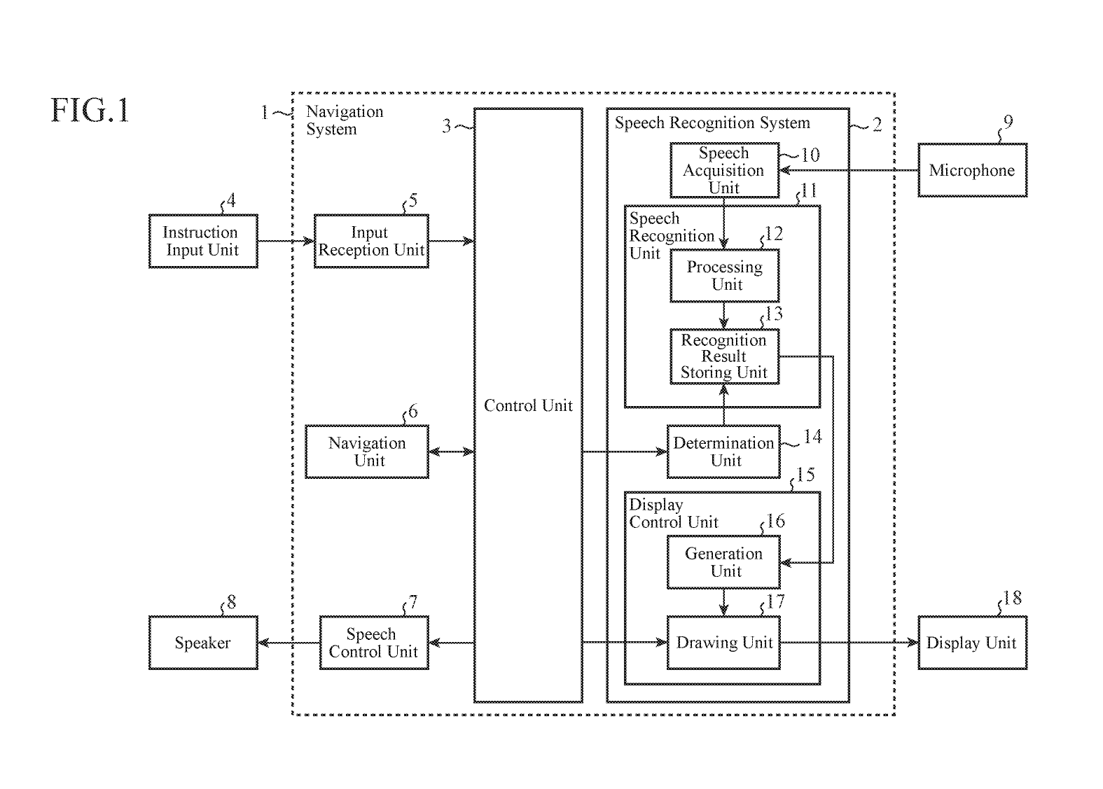

FIG. 1 is a block diagram illustrating an example of a navigation system 1 to which a speech recognition system 2 according to a first embodiment of the present invention is applied. The navigation system 1 includes a control unit 3, an input reception unit 5, a navigation unit 6, a speech control unit 7, a speech acquisition unit 10, a speech recognition unit 11, a determination unit 14, and a display control unit 15. The constituent units of the navigation system 1 may be distributed over a server on a network, a mobile terminal such as a smartphone, and an in-vehicle device.

Here, the speech acquisition unit 10, the speech recognition unit 11, the determination unit 14, and the display control unit 15 constitute the speech recognition system 2.

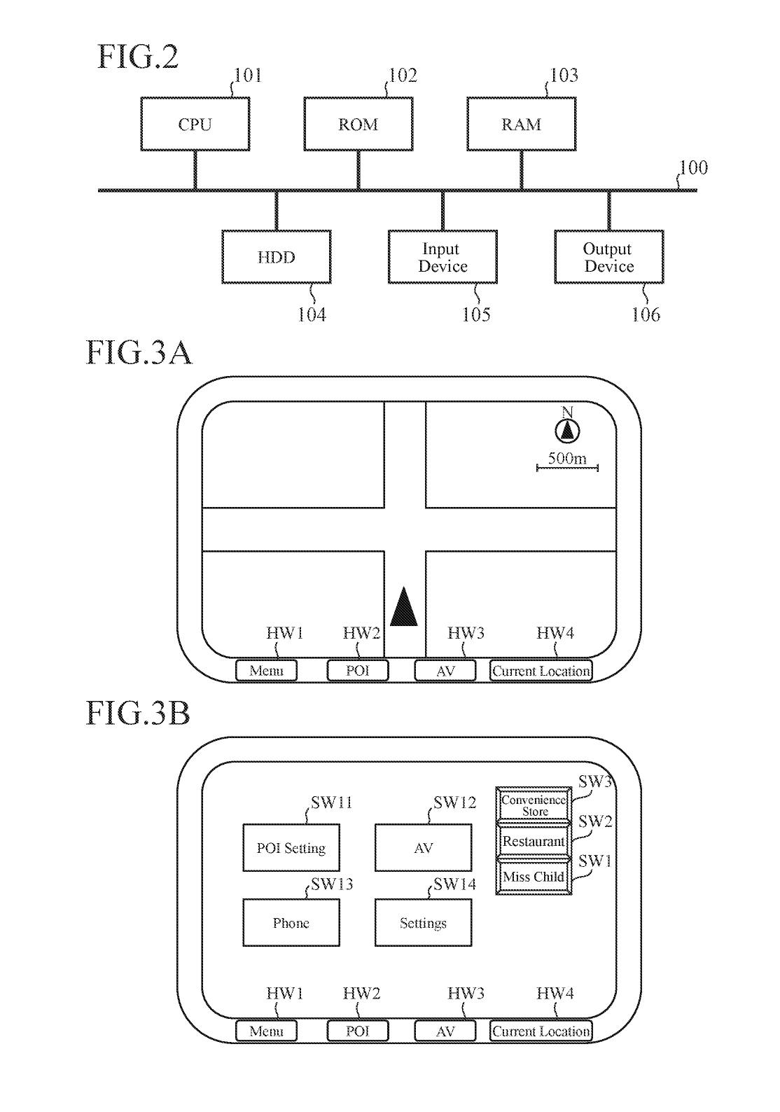

FIG. 2 is a schematic diagram illustrating a hardware configuration of the navigation system 1 and its peripheral devices, according to the first embodiment. A central processing unit (CPU) 101, a read only memory {RDM} 102, a random access memory (RAM) 103, a hard disk drive (HDD) 104, an input device 105, and an output device 106 are connected to a bus 100.

By reading out and executing various programs stored in the ROM 102 or the HDD 104, the CPU 101 implements the functions of the control unit 3, the input reception unit 5, the navigation unit 6, the speech control unit 1, the speech acquisition unit 10, the speech recognition unit 11, the determination unit 14, and the display control unit 15 of the navigation system 1, in cooperation with the other hardware devices. The input device 105 corresponds to an instruction input unit 4, the input reception unit 5, and a microphone 9. The output-device 106 corresponds to a speaker 8 and a display unit 18.

First, an overview of an operation of the speech recognition system 2 will be described.

The speech recognition system 2 continuously imports speech utterances, collected by the microphone 9 for a preset sound acquisition period, recognizes predetermined keywords, and holds recognition, results. Then, the speech recognition system 2 determines whether a user of a movable body has performed a predetermined operation on the navigation system 1. If such operation is performed, the speech recognition system 2 generates a function execution button for executing a function associated with the held recognition result, and outputs the generated function execution button to the display unit 18.

The preset sound acquisition period will be described later.

Here, suppose that when a map display screen as illustrated in FIG. 3A is displayed on a display of the display unit 18, and that the following conversation is made by a user A and a user B.
A: “Which track shall we play after this one”
B: “I want to listen to Miss Child as I haven't listened to it for a long time.”
A: “Sounds nice. By the way, what's to eat for lunch Do you want to go to a restaurant”
B: “I'll get something at a convenience store.”
A: “All right.”

At this time, the speech recognition system 2 recognizes, as keywords, an artist name “Miss Child” and facility category names “restaurant” and “convenience store.” But at this stage, the speech recognition system 2 does not display function execution buttons associated with the recognition results on the display unit 18. In addition, a “menu” button HW1, a “POI” button HW2, an “audio visual (AV)” button HW3, and a “current location” button HW4 that are illustrated in FIG. 3 are hardware (HW) keys installed on a display casing of the display unit 18.

After that, when the user B presses the “menu” button HW1 for displaying a menu, screen to search for a convenience store near the current location, a menu screen as illustrated in FIG. 3B is displayed. The speech recognition system 2 displays on the display unit 18 a “Miss Child” button SW1, a “restaurant” button SW2, and a “convenience store” button SW3, which are function execution buttons respectively associated with recognition results “Miss Child,” “restaurant,” and “convenience store.” These function execution buttons are software (SW) keys displayed on the menu screen. A “POI setting” button SW11, an “AV” button SW12, a “phone” button SW13, and a “setting” button SW14 are software keys, not function execution buttons.

Subsequently, when the user B presses the “convenience store” button SW3, which is a function execution button, the navigation unit 6 of the navigation system 1 searches for convenience stores near the current location, and displays a search result on the display unit 18. Note that the detailed description of the speech recognition system 2 will foe provided later.

On the other hand, in a case in which the user B tries to execute a search of a convenience store near the current location without using the “convenience store” button SW3, the user B performs, for example, an operation of pressing the “menu” button HW1 to display the menu screen, performs an operation of pressing the “POI setting” button SW11 on the menu screen to display a search screen for searching a point of interest (POI), performs an operation of pressing a “nearby facility search” button on the POI search screen to display a nearby facility search screen, and instructs search execution by setting “convenience store” as a search key. Thus, a function that is normally called out and executed by performing a plurality of times of operations can be called out and executed by operating a function execution button once.

The control unit 3 controls the entire operation of the navigation system 1.

The microphone 9 collects speeches uttered by users. Examples of the microphone 9 include, for example, an omnidirectional microphone, an array microphone comprising a plurality of omnidirectional microphones arranged in an array pattern to make the directional characteristic adjustable, a unidirectional microphone having directionality in only one direction and having unadjustable directional characteristic.

The display unit 18 is, for example, a liquid crystal display (LCD), or an organic electroluminescence (EL) display. Alternatively, the display unit 18 may be a display-integrated touch panel constituted by an LCD or organic EL display and a touch sensor.

The instruction input unit 4 is used to input instructions manually by the user. Examples of the instruction input unit 4 include, for example, a hardware button (key) and a switch, which are provided on a casing or the like of the navigation system 1, a touch sensor, a remote controller installed on a steering wheel or the like, a separate remote controller, a recognition device for recognizing instructions by gesture. Any touch sensor may be used, including a pressure-sensitive type, an electromagnetic induction type, a capacitance type, and any combination of these types.

The input reception unit 5 receives instructions input through the instruction input unit 4, and outputs the instructions to the control unit 3.

According to a user operation that is received by the input reception unit 5 and input via the control unit 3, the navigation unit 5 performs screen transition, or various types of search, such as a search by address and a facility search using map data snot shown). In addition, the navigation unit 6 calculates a route to an address or a facility set by the user, generates voice information and display content for route guidance, and instructs the display control unit 15 and the speech control unit 7, which will be described later, to output the generated speech information and display content via the control unit 3. Aside from the above-described operations, the navigation unit 6 may perform other operations, including music search using a music title, an artist name, or the like, playing of music, and executions of an operation of other in-vehicle devices, such as an air conditioner and other devices, according to instructions by the user,

The speech control unit 7 outputs guidance voice, music, etc., from the speaker 8, in response to the instruction by the navigation unit 6 via the control unit 3.

Next, constituent parts of the speech recognition system 2 will be described.

The speech acquisition unit 10 continuously imports speeches collected by the microphone 9, and performs analog-to-digital (A/D) conversion on the collected speeches using pulse code modulation (PCM), for example.

Here, the term “continuously” is used to mean “over a preset sound acquisition period,” and is not limited to the meaning of “always.” Examples of the “sound acquisition period” include, for example, a period of five minutes from the time when the navigation system 1 has been activated, a period of one minute from the time when a movable body has stopped, and a period from the time when the navigation system 1 has been activated to the time when the navigation system 1 stops. In the following, the description of first embodiment will be provided assuming that the speech acquisition, unit 10 imports speech during a period from, the time when the navigation system 1 has been activated to the time when the navigation system 1 stops.

Note that although the following description will be made by assuming that the microphone 9 and the speech acquisition unit 10 are separate units as explained above, the speech acquisition unit 10 may be built in the microphone 9.

The speech recognition unit 11 includes a processing unit 12 and a recognition result storing unit 13.

The processing unit 12 detects, from speech data digitalized by the speech acquisition unit 10, a speech section corresponding to a user's speech utterance (hereinafter, described as a “speaking section”), extracts features of the speech data in the speaking section, performs recognition processing based on the extracted features by using a speech recognition dictionary, and outputs a recognition result to the recognition result storing unit 13. The recognition processing can be performed by using a general method such as, for example, a hidden Markov model (HMM) method, as a method of recognition processing. Thus, detailed description of the recognition processing will be omitted.

Here, any method of speech recognition may be used, including word recognition based on grammar, keyword spotting, large vocabulary continuous speech recognition, and other known methods. In addition, the speech recognition unit. In may include known intention comprehension processing, and accordingly it may output a recognition result based on an intention of the user that is estimated or searched on the basis of the recognition result obtained using the large vocabulary continuous speech recognition.

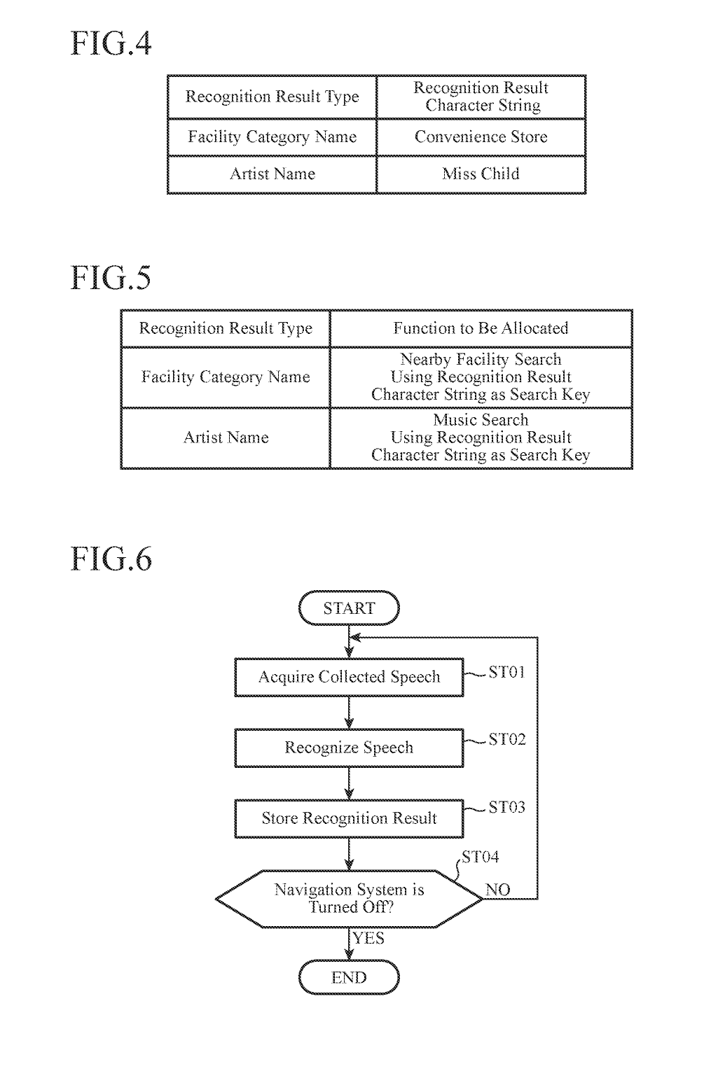

As a recognition result, the processing unit 12 outputs at least a recognition result character string and the type of a recognition result (hereinafter, described as a “recognition result type”). FIG. 4 shows examples of the recognition result character string and the recognition result type. For example, if a recognition result character string is “convenience; store,” the processing unit 11 outputs a recognition result type “facility category name.”

Note that the recognition result type is not limited to specific character strings. The recognition result type may be an ID represented by a number, or a dictionary name used when recognition processing is performed (name of a dictionary including a recognition result character string in the recognition vocabulary of the dictionary). Note that although the first embodiment will be explained assuming that the recognition target vocabulary of the speech recognition unit II includes facility category names, such as the “convenience store” and the “restaurant”, and an artist name such as “Miss Child,” the content of the recognition target vocabulary is not limited to these words or phrases.

The recognition result storing unit 13 stores a recognition result output by the processing unit 12. The recognition result storing unit 13 outputs the stored recognition result to a generation unit 16 when it receives an instruction from the determination unit 14, which will be described later, to output the stored recognition result.

Meanwhile, in a speech recognition function installed on car navigation systems or other systems, it is common that the user clearly indicates (instructs) the start of speech for the system. Thus, a button for instructing a speech recognition start (hereinafter, described as a “speech recognition start instruction part”) is displayed on a touch panel or provided on a steering wheel. After the user touches or presses the speech recognition start instruction part, the speech recognition starts to recognize speech utterances. In other words, when the speech recognition unit receives a speech recognition start signal output from the speech recognition start instruction part, the speech, recognition, unit detects a speaking section corresponding to a speech utterance made by the user from the speech data acquired by the speech acquisition unit after the signal has been received to perform the recognition processing described above.

In contrast to this, even if a speech recognition start instruction is not issued by the user as described above, the speech recognition unit 11 in the first embodiment continuously recognizes speech data imported by the speech acquisition unit 10. In other words, even if a speech recognition start signal is not received, the speech recognition unit 11 repeatedly performs processing of: detecting a speaking section corresponding to content spoken by the user from speech data acquired by the speech acquisition unit 10, extracting features of the speech data in the speaking section, performing recognition processing on the basis of the extracted features by using the speech recognition dictionary, and outputting a recognition result.

The determination unit 14 holds predefined user operations that serve as a trigger for displaying a function execution button associated with a recognition result of a user's speech utterance on the display unit 18. In other words, the determination unit 14 holds predefined user operations that serve as a trigger to be used when the determination unit 14 instructs the recognition result-storing unit 13 to output the recognition result stored in the recognition result storing unit 13 to the generation unit 16 to be described later.

Examples of user operations predefined in the determination unit 14 include, for example, the press of buttons associated with a function of displaying the menu screen indicating a list of functions of the navigation system 1, displaying the POI search screen, and displaying an AV screen, on the display unit 18. Here, examples of the buttons include, for example, software keys displayed on a display (e.g., “POI setting” button SW11 in FIG. 3B), hardware keys provided on, for example, a display casing (e.g., “menu” button HW1 in FIG. 3A), and keys of a remote controller.

The determination unit 14 acquires an operation input of the user from the input reception unit 5 via the control unit 3, and determines whether the acquired operation input matches any one of the predefined operations. If the acquired operation input matches a predefined operation, the determination unit 14 instructs the recognition result storing unit 13 to output the stored recognition result to the generation unit 16. On the other hand, if the acquired operation input does not match any of the predefined operations, the determination unit 14 does nothing.

The display control unit 15 includes the generation unit 16 and a drawing unit 17. The generation unit 16 acquires the recognition result from the recognition result storing unit 13, and generates a function execution button corresponding to the acquired recognition result.

Specifically, as illustrated in FIG. 5, the generation unit 16 holds information which defines a relation between a recognition result type and a function to be allocated to a function execution button (hereinafter, described as an “allocation function for a function execution button”) in association with the recognition result type. Then, the generation unit 16 determines an allocation function, for a function execution button that corresponds to a recognition result type included in the recognition result acquired from the recognition result storing unit 13. Furthermore, the generation unit 16 generates a function execution button to which the determined function is allocated. After that, the generation unit 16 instructs the drawing unit 17 to display the generated function execution button on the display unit 18.

For example, if a recognition result type included in a recognition result acquired from the recognition result storing unit 13 is “facility category name,” and if a recognition result character string is “convenience store”, the generation unit 16 refers to the table illustrated in FIG. 5, and determines that an allocation function for a function execution button is “nearby facility search using the “convenience store” as a search key.”

The drawing unit 17 displays, on the display unit 18, content, instructed by the navigation unit 6 via the control unit 3, and the function execution button generated by the generation unit 16.

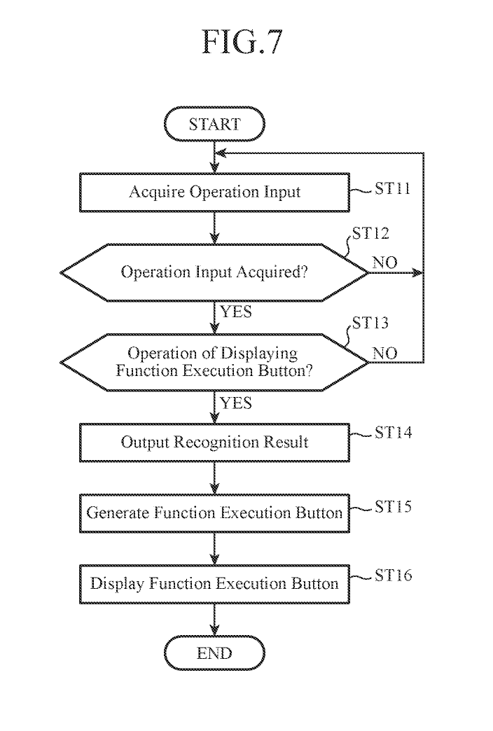

Next, operations of the speech recognition system 2 according to the first embodiment will be described using flowcharts illustrated in FIGS. 6 and 7, and specific examples. In addition, in the following, a user operation that serves as a trigger for displaying a function execution button on the display unit. 18 is assumed to be the press of any of the “menu” button HW1, the “POI” button HW2, and the “AV” button HW3, which are hardware keys installed on the periphery of the display, as illustrated in FIG. 3A. In addition, for simplifying the description, in the following description, the description of the action of the control unit 3 will be omitted.

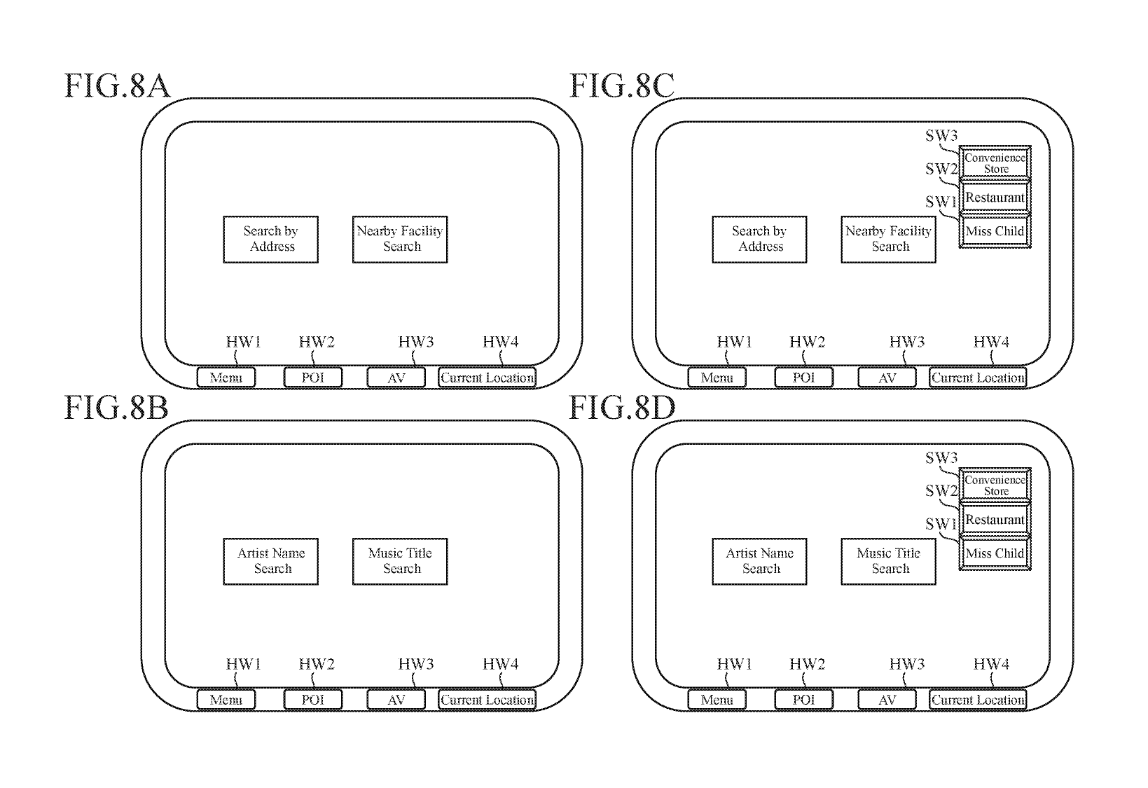

The “menu” button HW1 is provided for displaying the menu screen presenting various functions to the user, as illustrated in FIG. 3B. In addition, the “POT” button HW2 is provided for displaying the POI search screen as illustrated in FIG. 8A. In addition, the “AV” button HW3 is provided for displaying the AV screen as illustrated in FIG. 8B. Note that an operation performed after one of these hardware keys is pressed is a mere example, and thus the operation to be performed is not limited to the operation explained below.

First, the above-described conversation is assumed to be performed by the user A and the user B when the map display screen illustrated in FIG. 3A is being displayed.

FIG. 6 illustrates a flowchart of recognizing a user's speech utterance and holding a recognition result.

The description will now be given assuming that the speech acquisition unit 10 continuously imports speeches collected by the microphone 9, during a sound acquisition period from the time when the navigation system 1 is activated to the time when the navigation system 1 is turned off. First, the speech acquisition unit 10 imports a user's speech utterance collected by the microphone 9, i.e., an input speech, and performs A/D conversion using the PCM, for example (step ST01).

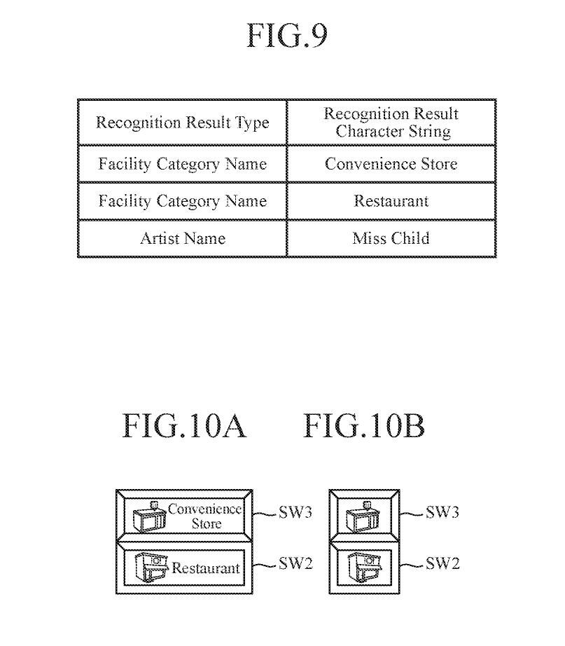

Next, the processing unit 12 detects, from speech data digitalized by the speech acquisition unit 10, a speaking section corresponding to content a speech utterance made by the user, extracts features of the speech data in the speaking section, performs recognition processing on the basis of the features using the speech recognition dictionary (step ST02), and stores a recognition result into the recognition result storing unit 13 (step ST03). As a result, as illustrated in FIG. 9, a recognition result is stored into the recognition result storing unit 13. Then, if the navigation system 1 is not turned off (“NO” at step ST04), the speech recognition system 2 returns the processing to the processing at step ST01, and if the navigation system 1 is turned off (“YES” at step ST04), the speech recognition system 2 ends the processing.

FIG. 7 illustrates a flowchart of displaying a function execution button.

First, the determination unit 14 acquires an operation input by the user from the input reception unit 5 (step ST11). If the operation input is acquired, that is, if some user operation has been performed (“YES” at step ST12), the determination unit 14 advances the processing to the processing at step ST13. On the other hand, if operation input cannot be acquired (“NO” at step ST12), the determination unit 14 returns the processing to the processing at step ST11.

Next, the determination unit 14 determines whether the operation input acquired from the input reception unit 5 matches a predefined operation. If the operation input acquired from the input reception unit 5 matches a predefined operation (“YES” at step ST13), the determination unit 14 instructs the recognition result storing unit 13 to output a stored recognition result to the generation unit 16. On the other hand, if the operation input acquired from the input reception unit 5 does not match any of the predefined operations (“NO” at step ST13), the determination unit 14 returns the processing to the processing at step ST11.

At this time, after the above-described conversation, the processing does not proceed to the processing at step ST13 until a hardware key such as the “menu” button HW1 is pressed by the user A or the user B.

Thus, even if a recognition target word “Miss Child”, “restaurant” , or “convenience store” is included in the speech utterance, no function execution button is displayed on the display unit 18 until the press.

If the user B desires to search for a convenience store near the current location, and performs a pressing operation of the “POI” button HW2 being an operation that serves as a trigger for executing the function (“YES” at steps ST11, ST12), because the pressing operation of the “POI” button HW2 matches an operation predefined by the determination unit 14 (“YES” at step ST13), the determination unit 14 instructs the recognition result storing unit 13 to output a stored recognition result to the generation unit 16. Similar processing will be performed in the event that the “menu” button HW1 or the “AV” button HW3 is pressed.

On the other hand, if the user B performs a pressing operation of the “current location” button HW4, because the operation does not match any of the operations predefined by the determination unit 14 (“NO” at step ST13), the processing does not proceed to the processing at step ST14, so that no function execution button is displayed on the display unit 18.

If the recognition result storing unit 13 receives an instruction from the determination unit 14, the recognition result storing unit 13 outputs recognition results stored at the time when the instruction is received, to the generation unit 16 (step ST14).

After that, the generation unit 16 generates one or more function execution buttons each corresponding to a recognition result acquired from the recognition result storing unit 13 (step ST15), and instructs the drawing unit 17 to display the generated function execution buttons on the display unit 18. Lastly, the drawing unit 17 displays the function execution button on the display unit 18 (step ST16).

Specifically, the recognition result storing unit 13 outputs the recognition results “Miss Child,” “convenience store,” and “restaurant” to the generation unit 16 (step ST14). After that, the generation unit 16 generates a function execution button to which a function of performing “music search using the “Miss Child” as a search key” is allocated, a function execution button to which a function of performing “nearby facility search using the “convenience store” as a search key” is allocated, and a function execution button to which a function of performing “nearby facility search using the “restaurant” as a search key” is allocated (step ST15), and instructs the drawing unit 17 to display the generated function execution buttons on the display unit 18.

The drawing unit 17 superimposes the function execution buttons generated by the generation unit 16 on a screen that is displayed according to the instruction from the navigation unit 6, and causes the display unit 18 to display the superimposed screen. For example, if the “menu” button HW1 is pressed by the user, as illustrated in FIG. 3B, the drawing unit 17 displays the menu screen instructed by the navigation unit 6, and displays the function execution buttons of the “Miss Child” button SW1, the “restaurant” button SW2, and the “convenience store” button SW3 that have been generated by the generation unit 16. In a similar manner, if the “POI” button HW2 and the “AV” button HW3 are pressed by the user, screens as illustrated in FIGS. 8C and 8D are displayed respectively. If a pressing operation of a function execution button is performed by the user, the navigation unit 6 that has received an instruction from the input reception unit 5 executes a function allocated to the function execution button.

As described above, according to the first embodiment, the speech recognition system 2 includes the speech acquisition unit 10 for acquiring speeches, uttered by a user over a preset sound acquisition period, the speech recognition unit 11 for recognizing the speeches acquired by the speech acquisition unit 10, the determination unit 14 for determining whether the user has performed a predetermined operation, and the display control unit 15 for displaying, on the display unit 18, a function execution button for causing the navigation system 1 to execute a function corresponding to a recognition result of the speech recognition unit 11. In the speech recognition system 2 according to the first embodiment, if speech is imported over the preset, sound acquisition period, and if it is determined by the determination unit 14 that the user has performed a predetermined operation, a function execution button that is based on a speech utterance is displayed. This can resolve the bother of pressing the PTT button to speak again the word appeared in conversation. In addition, operations that are against the intention of the user are not performed. Furthermore, impairment in concentration that is caused by screen update performed when the function execution button is displayed can be suppressed. Additionally, since a function execution button that foresees the operation intention of the user is presented for the user, user-friendliness and usability can be enhanced.

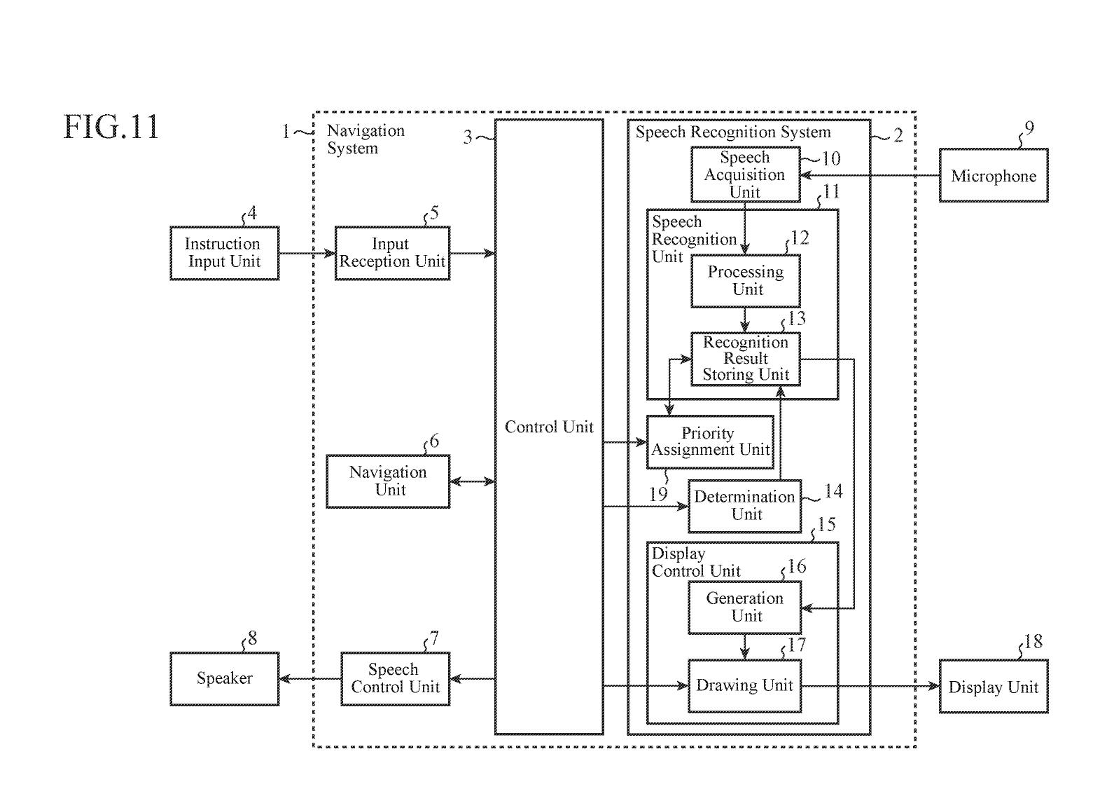

In addition, in the first embodiment, the description has been given assuming that the generation unit 16 generates a function execution button in which only a recognition result character string is displayed. Alternatively, an icon corresponding to a recognition result character string may be predefined, and a function execution button in which a recognition result character string and an icon are combined as illustrated in FIG. 10A, or a function execution button only including an icon corresponding to a recognition, result character string as illustrated in FIG. 10B may be generated. Also in the following second and third embodiments, a display form of a function execution button is a non-limiting feature.

By displaying a function execution button as described above, the user can intuitively understand the content of the function execution button.

In addition, the generation unit 16 may vary a display mode of a function execution button according to a recognition result type. For example, a display mode may be varied in such a manner that, in a function execution button corresponding to a recognition result type “artist name” a jacket image of an album of the artist is displayed, and in a function execution button corresponding to a recognition result type “facility category name” an icon is displayed.

By displaying a function execution button as described above, the user can intuitively understand the content of the function execution button.

In addition, the speech recognition system 2 may be configured to include a priority assignment unit for assigning a priority to a recognition result for each type, and the generation unit 16 may vary at least either one of the size and the display order of function execution buttons corresponding to recognition results on the basis of priorities of the recognition results.

For example, as illustrated in FIG. 11, the speech recognition system 2 includes a priority assignment unit 19. The priority assignment unit 19 acquires operation inputs of the user from the input reception unit 5 via the control unit 3, and manages the acquired operation inputs as an operation history. In addition, the priority assignment unit 19 observes the recognition result storing unit 13. When a recognition result is stored into the recognition result storing unit 13, the priority assignment unit 19 assigns a priority based on the past operations of the user included in the operation history to the recognition result. When outputting the recognition result to the generation unit 16, the recognition result storing unit 13 together outputs the priority given by the priority assignment unit 19.

Specifically, if the number of times facility search is manually performed using category names is larger than the number of times artist name search is performed, the priority assignment unit 19 assigns a higher priority to a recognition result having a recognition result type “facility category name,” than a priority assigned to a recognition result having a recognition result type “artist name.” Then, for example, the generation unit 16 generates function execution buttons in such a manner that the size of a function execution button corresponding to the recognition result with higher priority becomes larger than the size of a function execution button corresponding to the recognition result with lower priority. By displaying function execution buttons in this manner, as well, a function execution button considered to be required by the user can be emphasized. This enhances convenience.

In addition, when displaying a function execution button on the display unit 18, the drawing unit 17 displays a function execution button corresponding to a recognition result with higher priority, above a function execution button corresponding to a recognition result with lower priority. By displaying function execution buttons in this manner, a function execution button considered to be required by the user can be emphasized. This enhances convenience.

Furthermore, whether or not to output a function execution button may be varied based on the priority of a recognition result. For example, the drawing unit 17 may be configured to preferentially output a function execution button corresponding to a recognition result with higher priority if the number of function execution buttons generated by the generation unit 16 exceeds the upper limit of a predetermined number of buttons to be displayed, and not to display the other function execution buttons if the number of function execution buttons exceeds the upper limit number. By displaying function execution buttons in this manner, a function execution button considered to be required by the user can be preferentially displayed. This enhances convenience.

Although, in the first embodiment, the display of a function execution button has been explained assuming that function execution buttons are triggered by the user operation of a button such as a hardware key or a software key, the display of a function execution button may be triggered by the user performing a predetermined action. Examples of such actions performed by the user include, for example, speaking and gesture.

Below, description of parts that, are different from the above-described constituent parts in processing will be made. In addition to the category name and the like that are described above, the recognition target vocabulary used by the processing unit 12 includes commands for operating a controlled device such as, for example, “phone” and “audio”, and speech utterances that are considered to include operation intention for the controlled device, such as “I want to go”, “I want to listen to,” and “send mail.” Then, the processing unit 12 outputs a recognition result not only to the recognition result storing unit 13 but also to the determination unit 14.

In the determination unit 14 speech utterances that serve as a trigger for displaying a function execution button are predefined, in addition to the above-described user operations. For example, speech utterances such as “I want to go”, “I want to listen to,” and “audio” are predefined. Then, the determination unit 14 acquires a recognition result output by the processing unit 12, and if the recognition result matches any of the predefined speech utterances, instructs the recognition result storing unit 13 to output the stored recognition result to the generation unit 16.

Furthermore, a gesture action of the user looking around the own vehicle or tapping a steering wheel may trigger the speech recognition system 2 to display a function execution button. More specifically, the determination unit 14 acquires information measured by a visible light camera (not illustrated), an infrared camera (not illustrated), or the like that is installed in a vehicle, and detects the movement of a face from the acquired information. Then, if the face reciprocates in a range of horizontal 45 degrees in 1 second, when the angle at which the face faces the front with respect to the camera is assumed to be 0 degree, the determination unit 14 determines that the user is looking around the own vehicle.

Furthermore, if a user operation or the like that serves as a trigger for displaying a function execution button is performed, the drawing unit 17 may display the function execution button so as to be superimposed on a screen being displayed, without-performing screen transition corresponding to the operation or the like. For example, if the user presses the “menu” button HW1 when the map display screen illustrated in FIG. 3A is being displayed, the drawing unit 17 displays a function execution button after shifting the screen to the menu screen illustrated in FIG. 3B. On the other hand, if the user performs an action of tapping the steering wheel, the drawing unit 17 displays a function execution button on the map display screen illustrated in FIG. 3A.

### Second Embodiment

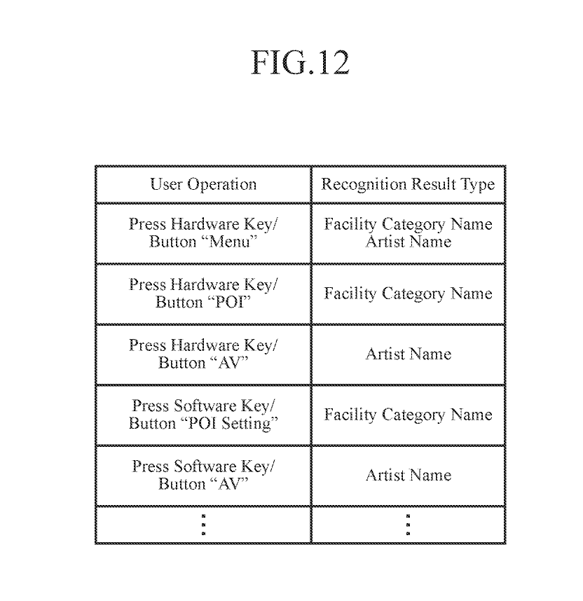

A block diagram illustrating an example of a navigation system to which a speech recognition system according to a second embodiment of the present invention is applied is the same as the block diagram illustrated in FIG. 1 in the first embodiment. Thus, the diagram and description will be omitted. The following second embodiment differs from the first embodiment in that the determination unit 14 stores user operations and recognition result types in association with each other, as illustrated in FIG. 12, for example. Hardware keys in FIG. 12 refer to, for example, the “menu” button HW1, the “POI” button HW2, the “AV” button HW3, and the like that are installed on the peripheral of the display as illustrated in FIG. 3A. In addition, software keys in FIG. 12 refer to, for example, the “POI setting” button SW11, the “AV” button SW12, and the like that are displayed on the display as illustrated in FIG. 3B.

The determination unit 14 of the second embodiment acquires an operation input of the user from the input reception unit 5, and determines whether the acquired operation input matches a predefined operation. Then, if the acquired operation input matches the predefined operation, the determination unit 14 determines a recognition result type corresponding to the operation input. After that, the determination unit 14 instructs the recognition result storing unit 13 to output a recognition result having the determined recognition result type, to the generation unit 16. On the other hand, if the acquired operation input does not match, the predefined operation, the determination, unit 14 does nothing.

If the recognition result storing unit 13 receives an instruction from the determination unit 14, the recognition result, storing unit 13 outputs, a recognition result having a recognition result, type matching the recognition result type instructed by the determination unit 14, to the generation unit 16.

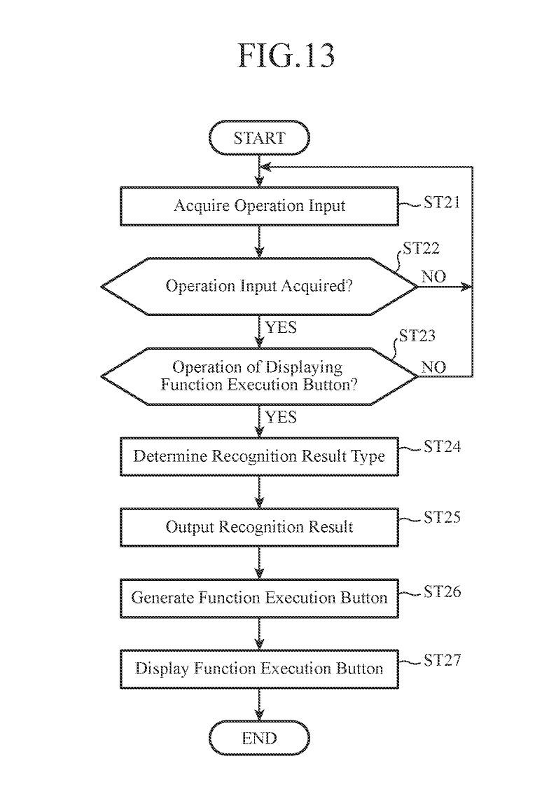

Next, operations of a speech recognition system. 2 according to the second embodiment will foe described using a flowchart illustrated in FIG. 13, and specific examples. In addition, in this example, user operations that serve as triggers for displaying function execution buttons on the display unit 18 are assumed to be operations defined in FIG. 12. In addition, conversation performed by the users is assumed to be the same as that in the first embodiment.

In the second embodiment, a flowchart of recognizing user's speech utterances and holding a recognition result is the same as the flowchart illustrated in FIG. 6. Thus, the description will be omitted. In addition, the processing at steps ST21 to ST23 in the flowchart illustrated in FIG. 13 is the same as the processing at steps ST11 to ST13 in the flowchart illustrated in FIG. 7. Thus, the description will be omitted. In addition, in the following description, it is assumed that the processing in FIG. 6 has been executed, and recognition results are stored in the recognition result storing unit 13 as illustrated in FIG. 9.

If the operation input of the user that has been acquired from the input reception unit 5 matches any one of the predefined operations (“YES” at step ST23), the determination unit 14 determines a recognition result type corresponding to the operation input, and then, instructs the recognition result storing unit 13 to output a recognition result having the determined recognition result type, to the generation, unit 16 (step ST24).

Next, if the recognition result storing unit 13 receives an instruction from the determination unit 14, the recognition result storing unit 13 outputs a recognition result having a recognition result type matching the recognition result type instructed by the determination unit 14, to the generation unit 16 (step ST25).

Specifically, if the user B desires to search for a convenience store near the current location, and performs a pressing operation of the “POI” button HW2 being an operation that serves as a trigger for executing the function (“YES” at steps ST21, ST22), because the pressing operation of the “POI” button HW2 matches an operation predefined by the determination unit 14 (“YES” at step ST23), the determination unit 14 refers to the table illustrated in FIG. 12, and determines a “facility category name” as a recognition result type corresponding to the operation (step ST24). After that, the determination unit 14 instructs the recognition result storing unit 13 to output a recognition result having the recognition result type “facility category name,” to the generation unit 16.

If the recognition result storing unit 13 receives an instruction from the determination unit 14, the recognition result storing unit 13 outputs recognition results having the recognition result type “facility category name,” that is, recognition results having recognition result character strings “convenience store” and “restaurant,” to the generation unit 16 (step ST25).

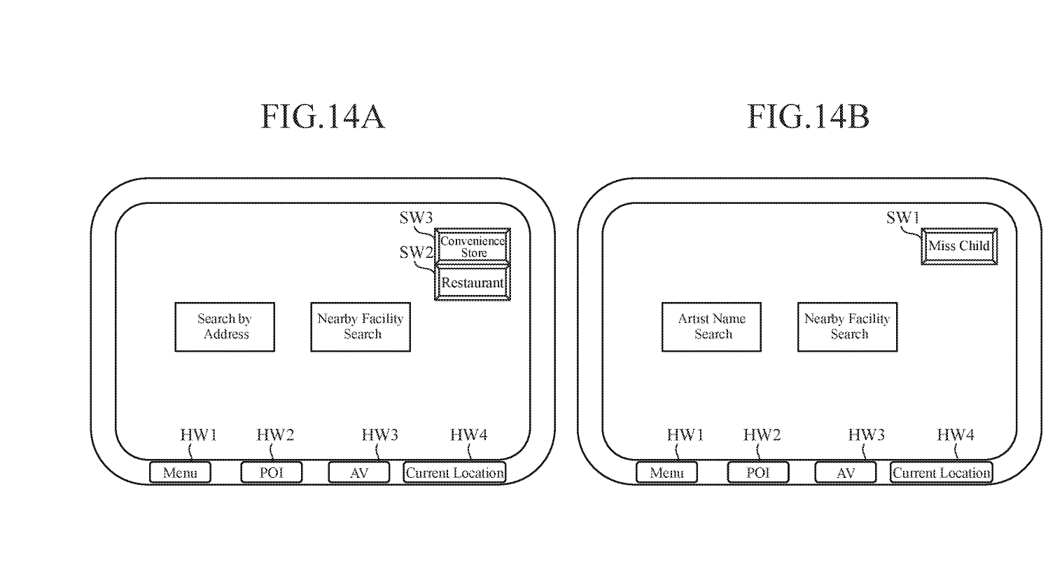

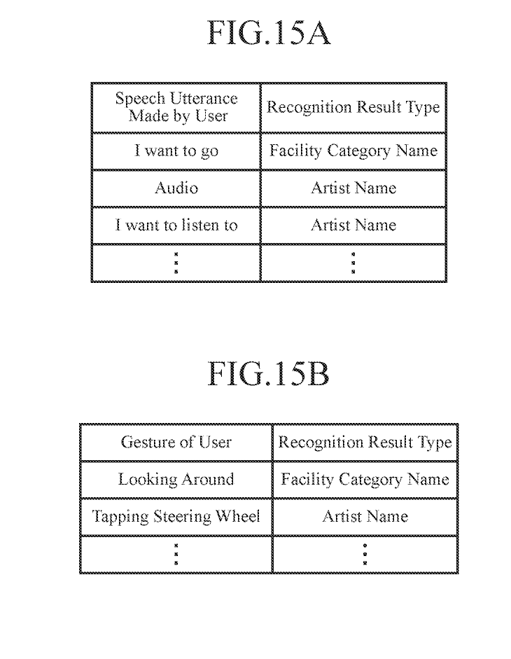

After that, the generation unit 16 generates a function execution button to which a function of performing “nearby facility search using the “convenience store” as a search key” is allocated, and a function execution button to which a function of performing “nearby facility search using the “restaurant” as a search key” is allocated (step ST26). The drawing unit 17 displays, on the display unit 18, the function execution buttons of the “convenience store” button SW3 and the “restaurant” button SW2, as illustrated in FIG. 14A (step ST27).

In a similar manner, if the user B performs a pressing operation of the “AV” button HW3, the “Miss Child” button SW1 being a function execution button to which a function of performing “music search using the “Miss Child” as a search key” is allocated is displayed on the display unit 18 as illustrated in FIG. 14B.

In addition, using not only operation inputs of the user, but also action inputs (speaking, gesture, etc.) of the user as triggers, a function execution button having high association with the action content may be displayed. In this case, as illustrated in FIGS. 15A and 15B, the determination unit 14 stores speech utterances of the user or gestures of the user, in association with a recognition result type, and the determination unit 14 may be configured to output a recognition result type matching the speech utterance of the user that has been acquired from the speech recognition unit 11, or the gesture of the user that has been determined based on information acquired from a camera or a touch sensor, to the recognition result storing unit 13.

As described above, according to the second embodiment, using information indicating correspondence relationship between an operation or an action performed by the user, and a type of a recognition result of the speech recognition unit 11, the determination unit 14 determines a corresponding type if it is determined that the user has performed the operation or the action, and the display control unit 15 selects a recognition result matching the type determined by the determination unit 14, from among recognition results of the speech recognition unit 11, and displays, on the display unit 18, a function execution button for causing the navigation system 1 to execute a function corresponding to the selected recognition result. With this configuration, a function execution button having high association with content operated by the user or the like can be presented. Thus, an operation intention of the user is foreseen more correctly and presented for the user. Thus, user-friendliness and usability can be further enhanced.

### Third Embodiment

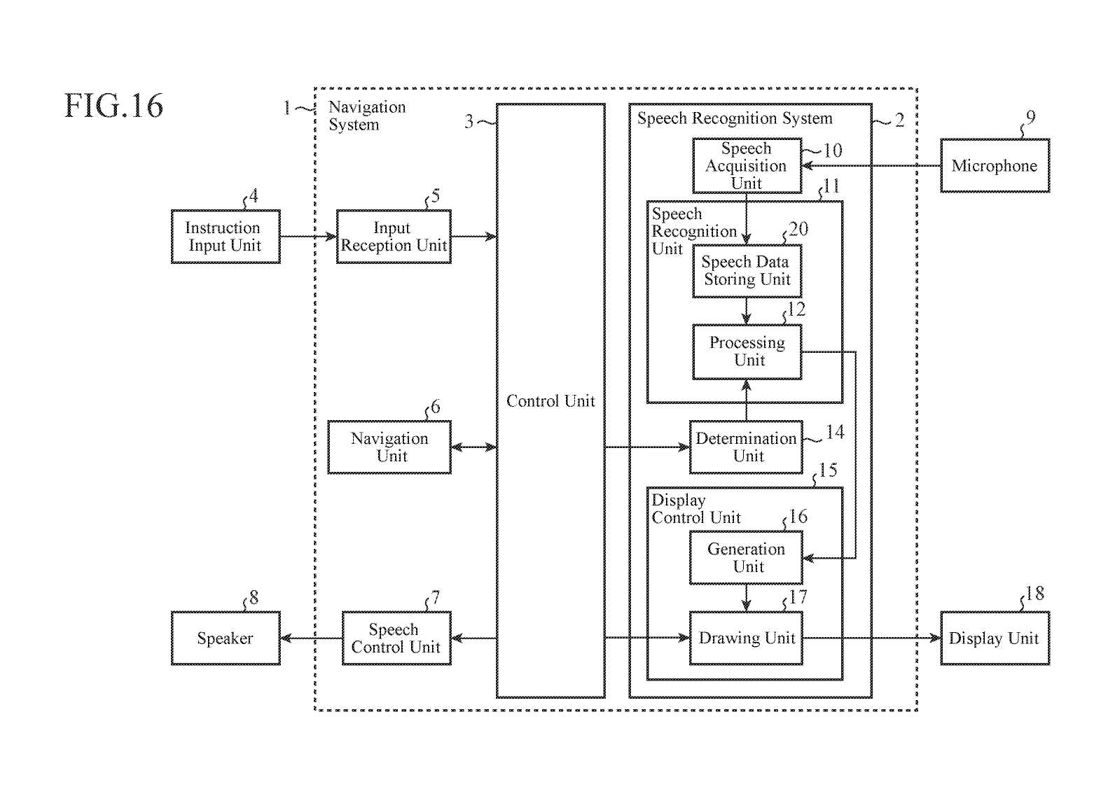

FIG. 16 is a block diagram illustrating an example of a navigation system 1 to which a speech recognition system 2 according to a third embodiment of the present invention is applied. In addition, parts similar to those described in the first embodiment are assigned the same signs, and the redundant description will be omitted.

In the following third embodiment, as compared with the first embodiment, the speech recognition system 2 does not include the recognition result storing unit 13. In place of this, the speech recognition system 2 includes a speech data storing unit 20. All or part of speech data obtained by the speech acquisition unit 10 continuously importing speech collected by the microphone 3, and digitalizing the speech through A/D conversion is stored into the speech data storing unit 20.

For example, the speech acquisition unit 10 imports speeches collected by the microphone 9 for a sound acquisition period, e.g., 1 minute from the time when the movable body stops, and stores digitalized speech data into the speech data storing unit 20. In addition, if the speech acquisition unit 10 imports speeches collected by the microphone 9 for a sound acquisition period, e.g., a period from the time when the navigation system 1 has been activated to the time when the navigation system 1 stops, the speech acquisition unit 10 stores speech data corresponding to past 30 seconds into the speech data storing unit 20. In addition, the speech acquisition unit 10 may be configured to perform processing of detecting a speaking section from speech data, and extracting the section, instead of the processing unit 12, and the speech acquisition unit 10 may store speech data of the speaking section into the speech data storing unit 20. In addition, speech data corresponding to a predetermined number of speaking sections may be stored into the speech data storing unit 20, and a piece of speech data exceeding the predetermined number of speaking sections may be deleted sequentially from the old one.

Furthermore, the determination unit 14 acquires operation inputs of the user from the input reception unit 5, and if an acquired operation input matches a predefined operation, the determination unit 14 outputs a speech recognition start instruction to the processing unit 12.

Furthermore, if the processing unit 12 receives the speech recognition start instruction from the determination unit 14, the processing unit 12 acquires speech data from the speech data storing unit 20, performs speech recognition processing on the acquired speech data, and outputs a recognition result to the generation unit 16.

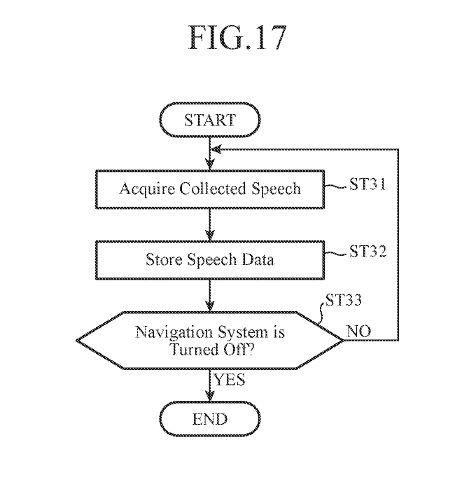

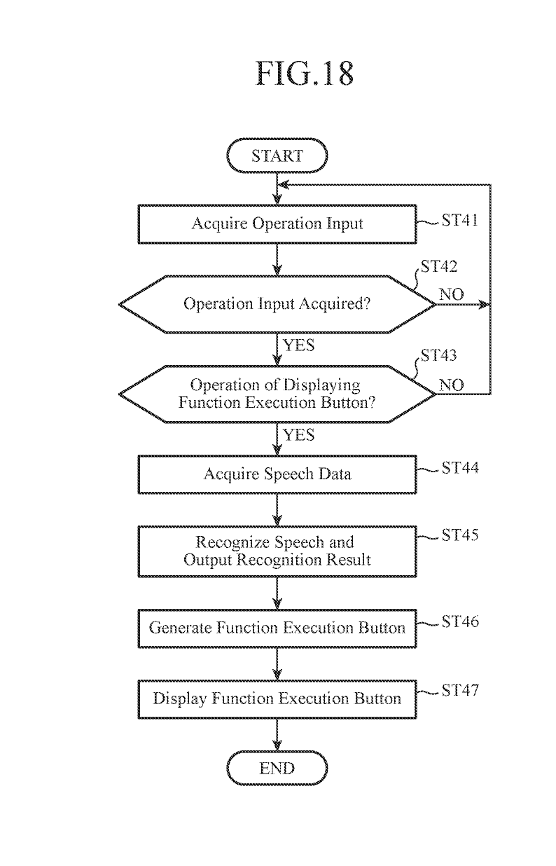

Next, operations of the speech recognition system 2 according to the third embodiment will be described using flowcharts illustrated in FIGS. 17 and 18. In addition, in this example, the speech acquisition unit 10 is assumed to import speech collected by the microphone 9, during a period from when the navigation system 1 has been activated, to when the navigation system 1 stops, as a sound acquisition period, and speech data corresponding to past 30 seconds of the imported speech is assumed to be stored in the speech data storing unit 20.

FIG. 1 illustrates a flowchart of importing and holding user speaking. First, the speech acquisition unit 10 imports a user's speech utterance collected by the microphone 9, i.e., input speech, and performs A/D conversion using the PCM, for example (step ST31). Next, the speech acquisition unit 10 stores digitalized speech data into the speech data storing unit 20 (step ST32). Then, if the navigation system 1 is not turned off (“NO” at step ST33), the speech acquisition unit 10 returns the processing to the processing at step ST31, and if the navigation system 1 is turned off (“YES” at step ST33), the speech acquisition unit 10 ends the processing.

FIG. 18 illustrates a flowchart of displaying a function execution button. Since the processing at steps ST41 to ST43 is the same as the processing at steps ST11 to ST13 in the flowchart illustrated in FIG. 7, the description will be omitted.

If the operation input of the user that is acquired from the input reception unit 5 matches a predefined operation (“YES” at step ST43), the determination unit 14 outputs a speech recognition start instruction to the processing unit 12. If the processing unit 12 receives the speech recognition start instruction from the determination unit 14, the processing unit 12 acquires speech data from the speech data storing unit 20 (step ST44), performs speech recognition processing on the acquired speech data, and outputs a recognition result to the generation unit 16 (step ST45).

As described above, according to the third embodiment, if it is determined by the determination unit 14 that the user has performed a predetermined operation or action, the speech recognition unit 11 recognizes speech acquired by the speech acquisition unit ID over a sound acquisition period. With this configuration, when speech recognition processing is not performed, resources such as memory and other devices can be allocated, to other types of processing such as map screen drawing processing, and response speed with respect to user operations other than a speech operation can be increased.

It should be noted that combination, modification or omission of any parts of embodiments described above may be made freely within the scope of the present invention.

### INDUSTRIAL APPLICABILITY

A speech recognition system according to the present invention presents a function execution button at a timing required by the user. Thus, the speech recognition system is suitable for being used as a speech recognition system for continuously recognizing speech utterances of the user, for example.

### REFERENCE SIGNS LIST

1: navigation system (device to be controlled), 2: speech recognition system, 3: control unit, 4: instruction input unit, 5: input reception unit, 6: navigation unit, 7: speech control unit, 8: speaker, 9: microphone, 10: speech acquisition unit, 11: speech recognition unit, 12: processing unit, 13: recognition result storing unit, 14: determination unit, 15: display control unit, 16: generation unit, 17: drawing unit, 18: display unit, 19: priority assignment unit, 20: speech data storing unit, 100: bus, 101: CPU, 102: ROM, 103: RAM, 104: HDD, 105: input device, and 106: output device

1. A speech recognition system comprising:
a processor to execute a program; and
a memory to store the program which, when executed by the processor, performs processes of:
acquiring speeches uttered by a user for a preset sound acquisition period;
recognizing the acquired-speeches by the speech acquisition unit;
determining whether the user performs a predetermined operation or action that serves as a trigger for causing a display to display a function execution button to which a predefined function is assigned for a result of the recognition; and
displaying, when it is determined that the user performs the predetermined operation or action, the function execution button for causing a device to be controlled to execute the predefined function corresponding to a for the result of the recognition on the display unit.

2. The speech recognition system according to claim 1, wherein the processes further comprises:
determining a type corresponding to the operation or action that is determined to be performed by the user by using information indicating correspondence relationship between an operation or an action performed by the user and a type of a recognition result; and
selecting a recognition result that matches the type determined from among recognition results, and displaying, on the display, the function execution button for causing the device to be controlled to execute the predefined function for the selected recognition result.

3. The speech recognition system according to claim 1, wherein a display mode of the function execution button is varied according to a type of recognition result.

4. The speech recognition system according to claim 3, the processes further comprising: assigning a priority to a recognition result for each type,
wherein a display mode of the function execution button is varied based on a priority assigned to a recognition result.

5. The speech recognition system according to claim 1, wherein the processes further comprises: recognizing speeches that have been acquired by the speech acquisition unit over the sound acquisition period, if it is determined that the user performs the predetermined operation or action.
